(19) United States
(12) Patent Application Publication
(10) Pub. No.: US 2021/0390533 A1
(43) Pub. Date: Dec. 16, 2021

(54) User-Centric, Blockchain-Based and End-to-End Secure Home IP Camera System

(71) Applicant: Hyperconnect Lab Inc., Menlo Park, CA (US)

(72) Inventors: Xinxin Fan, Menlo Park, CA (US); Zhi Zhong, Menlo Park, CA (US); Qi Chai, Menlo Park, CA (US); Dong Guo, Menlo Park, CA (US); Tian Pan, Menlo Park, CA (US)

(21) Appl. No.: 17/344,188

(22) Filed: Jun. 10, 2021

Related U.S. Application Data
(60) Provisional application No. 63/037,730, filed on Jun. 11, 2020.

(51) Int. Cl. G06Q 20/38; G06Q 20/36; H04L 9/08

(52) U.S. Cl. CPC G06Q 20/388; G06Q 20/3825; G06Q 20/3829; H04L 2209/38; H04L 9/0822; H04L 2209/56; G06Q 20/363

(57) ABSTRACT

A method of authenticating a client device to access a user account stored on a remote server includes creating the user account based on a blockchain address of a blockchain wallet, transmitting a login request for logging into the user account from the client device to the remote server, and transmitting a random challenge from the remote server to the client device when the remote server receives the transmitted login request. The random challenge is associated with the user account and no other user account. The method further includes signing the random challenge with the client device, the signature based on a private key of the blockchain wallet, transmitting the signed random challenge and the blockchain address to the remote server, and verifying that the signed random challenge corresponds to the transmitted random challenge with the remote server using a public key of the blockchain wallet and the random challenge.

This application claims the benefit of priority of U.S. provisional application Ser. No. 63/037,730, filed on Jun. 11, 2020, the disclosure of which is herein incorporated by reference in its entirety.

### FIELD

The disclosure relates to the field of the Internet of Things (IoT) and, in particular, to using blockchain architecture in connection with Internet Protocol (IP) cameras to improve a user experience by providing secure authentication and encrypted video.

### BACKGROUND

With the growing adoption of smart homes and the expanding consciousness regarding the security and safety of Internet-connected devices, the demand for IP-based camera systems has increased at a staggering rate. According to a recent market analysis report, the global home security camera market accounted for $2.76 billion in 2017 and is expected to reach $8.78 billion by 2026 growing at a compound annual growth rate of 13.7% during the forecast period. With features ranging from face recognition and multiple connectivity options, home IP cameras offer several key benefits, such as remote and perimeter video surveillance and intruder detection and alarms, thereby making IP cameras a desirable smart device for improving residential security.

While home IP camera systems redefine safety and protection of properties and businesses, the security and privacy of the data generated by IP cameras is a major concern for consumers. For example, hackers have broken into IP camera systems and have exposed some security design issues, including but not limited to poor password policies, problematical login processes, vulnerable firmware, and leaky databases. These vulnerabilities allow attackers to gain control of the IP cameras remotely and put users' personal information and privacy at risk.

Manufacturers have started to improve the security of IP cameras by using features such as two-factor authentication and IP logging; however, the security and privacy of IP cameras are still far from satisfactory. For example, the traditional login approach of usernames and passwords is still widely used as an authentication method in the user login process of existing IP cameras. The traditional login approach has become the root cause for many recent attacks in which hackers launch so-called “credential stuffing attacks” to access an account using a list of compromised login credentials. While these attacks could be mitigated by enabling a two-factor authentication mechanism, such an approach undesirably increases the complexity of the login process for users.

In addition to cumbersome login processes, the device binding mechanism that associates a user's account with his/her IP camera poses another major threat to the security and privacy of the data generated by IP camera systems. For example, some IP camera systems utilize cloud services for storing video clips, in which video files are stored either in plaintext or encrypted form with the encryption key held by the cloud service provider (CSP) and/or the manufacturer. This practice exposes users' private information to third-party entities and allows the third-party entities to arbitrarily manipulate the stored video clips. Moreover, while some IP camera systems enable owners to share live camera feeds with friends and family, stored video clips are only accessible by the camera owners. A process for sharing video clips and live streaming videos in an encrypted form has not been addressed or provided by manufacturers.

Based on the above, a strong need exists for increasing further the security and privacy of IoT devices, such as the systems and data associated with IP cameras, all without compromising the user experience.

### SUMMARY

According to an exemplary embodiment of the disclosure, a method of authenticating a client device to access a user account stored on a remote server includes creating the user account based on a blockchain address of a blockchain wallet, transmitting a login request for logging into the user account from the client device to the remote server, and transmitting a random challenge from the remote server to the client device when the remote server receives the transmitted login request. The random challenge is associated with the user account and no other user account. The method further includes signing the random challenge with the client device, the signature based on a private key of the blockchain wallet, transmitting the signed random challenge and the blockchain address to the remote server, and verifying that the signed random challenge corresponds to the transmitted random challenge with the remote server using a public key of the blockchain wallet and the random challenge. The method also includes authenticating the client device to access the user account when the verification succeeds, and denying authentication when the verification is unsuccessful to prevent the client device from accessing the user account.

According to another exemplary embodiment of the disclosure, a method of binding a client device to a user account stored on a remote server includes providing a blockchain address of the user account to the client device, the blockchain address stored on a blockchain, transmitting the provided blockchain address of the user account and a blockchain address of the client device to the blockchain, and executing a smart contract on the blockchain based on the transmitted blockchain address of the user account and the transmitted blockchain address of the client device. The executed smart contract is configured to bind the client device to the user account.

According to a further exemplary embodiment of the disclosure, an Internet-connected imaging device includes an image sensor configured to generate unencrypted image data, a memory operably connected to the image sensor, and a secure element operably connected to the image sensor and the memory. The secure element includes a private key of a blockchain wallet and a cryptographic engine. The cryptographic engine is configured (i) to derive a key encryption key based on the private key of the blockchain wallet, (ii) to store the key encryption key in the secure element, (iii) to derive a video encryption key, (iv) to encrypt the video encryption key based on the key encryption key, and (v) to store the encrypted video encryption key in the secure element. The cryptographic engine is further configured to encrypt the unencrypted image data based on the video encryption key to generate encrypted image data.

According to yet another exemplary embodiment of the disclosure and to overcome at least some of the above-described issues, a user-centric and end-to-end secure home IP camera system is disclosed herein. The IP camera system leverages a blockchain wallet generated on a mobile application (i.e. a mobile app) to enhance the security of the user login process by realizing a one-click, passwordless user authentication mechanism. Moreover, the resurrecting duckling security model is applied to the IP camera system for securely binding client devices with their owners. In particular, critical device ownership information is directly anchored to a blockchain by IP camera devices in lieu of the critical device ownership information being maintained by a centralized database server, thereby reducing the risk of the IP camera devices being taken over by attackers significantly. For protecting users' privacy, the IP camera system disclosed herein realizes end-to-end encryption coupled with a user-centric key management scheme. To thwart potential system errors and misbehavior of content security policies (CSPs), the IP camera system disclosed herein allows IP camera devices to periodically commit integrity checkpoints to the blockchain via user configuration, thereby enabling users to check data integrity when downloading video clips from local or remote storage. The improved IP camera system disclosed herein also realizes effective sharing of encrypted video clips and live streaming videos through re-encryption with Intel SGX, for example, and key refreshing, respectively.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 is a block diagram of an IP camera system, as disclosed herein, that includes an IP camera device, a smartphone, a blockchain, an IoT cloud, and a peer-to-peer (P2P) service;

FIG. 2 is a block diagram of the IP camera device of FIG. 1;

FIG. 3 is a block diagram of the blockchain of FIG. 1;

FIG. 4 is a flowchart illustrating an exemplary method of passwordless authentication for the IP camera of FIG. 1;

FIG. 5 is a flowchart illustrating an exemplary method of determining ownership of the IP camera of FIGS. 1; and

FIG. 6 is a block diagram of a Merkle tree approach for protecting the data integrity of the IP camera system of FIG. 1.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

Aspects of the disclosure are disclosed in the accompanying description. Alternate embodiments of the disclosure and their equivalents may be devised without parting from the spirit or scope of the disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the disclosure, the phrase “A and/or B” means (A), (B), or (A and B). For the purposes of the disclosure, the phrase “A, B, and/or C” means (A), (B), (C), (A and B), (A and C), (B and C), or (A, B, and C).

The terms “comprising,” “including,” “having,” and the like, as used with respect to embodiments of the disclosure, are synonymous.

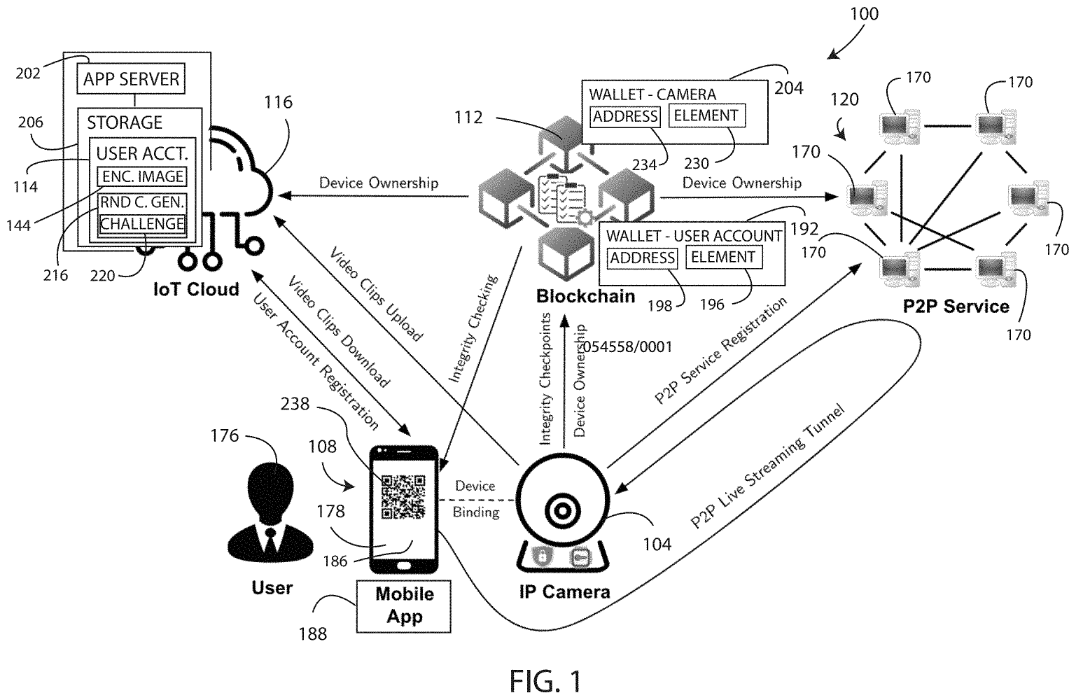

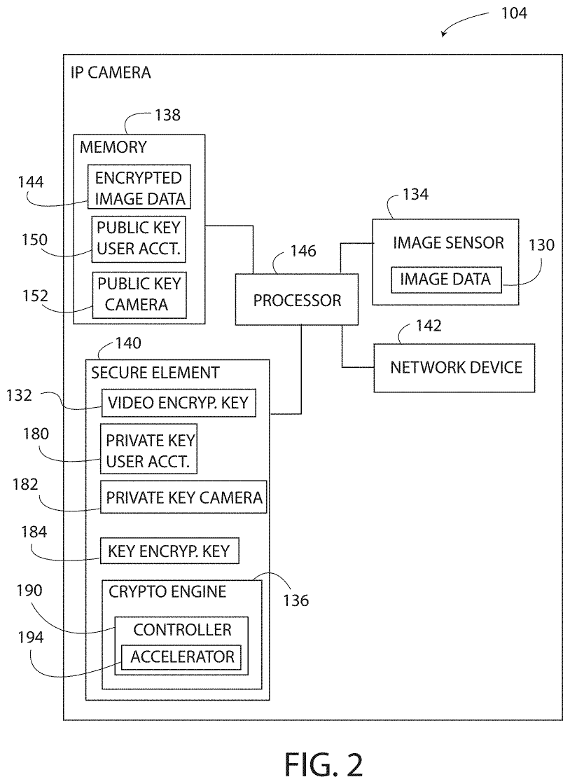

As shown in FIG. 1, an IP camera system 100 includes an IP camera device 104 (i.e. an Internet-Protocol camera) operatively connected to a smartphone 108, a blockchain 112, an IoT cloud 116, and a peer-to-peer (P2P) service 120 via the Internet. As disclosed herein, in one embodiment, the IP camera device 104 uses the blockchain 112 and an associated blockchain wallet 192 to replace the traditional username and password login approach for accessing a remote user account 114 associated with the IP camera device 104. The blockchain 112 is also used in a new approach for binding the IP camera 104 with the smartphone 108. Moreover, data, such as image data 130 (FIG. 2) generated by the IP camera device 104, is transmitted as encrypted image data 144 from the IP camera 104 to the IoT cloud 116 and the smartphone 108 using end-to-end encryption. The elements of the IP camera system 100 and methods 400, 500 for operating the IP camera system 100 are described herein.

With reference to FIG. 2, the IP camera device 104, also referred herein as an IP camera, an Internet-Protocol camera, a security camera, a client device, an Internet-connected imaging device, and/or a webcam, is a digital video camera configured to receive control commands, to generate the image data 130, and to transmit the encrypted image data 144 via the Internet or another network connection. Exemplary features of the IP camera 104 include generating full HD video and images, generating and transmitting a live stream of the encrypted image data 144, night vision, two-way audio, and motion detection and notification. In an exemplary embodiment, the IP camera 104 includes an image sensor 134, an electronic memory 138, a secure hardware element 140, and a network device 142 each operatively connected to a processor 146.

The image sensor 134 is configured to generate the image data 130, which corresponds to still images, motion data, video data, and/or video clips. The image data 130 may also include corresponding audio data. The image data 130 is also referred to herein as unencrypted image data 130, because the image data 130 generated by the image sensor 134 is in a standard video file format and/or image file format suitable for processing by a computer, smartphone, and/or telephone to generate videos and/or images on a corresponding display.

The memory 138 of the IP camera 104 is a non-transitory computer readable storage medium that is configured to store data and programming instructions for operating the IP camera 104 and the IP camera system 100. Additionally, the memory 138 is configured to store the encrypted image data 144 and any other data for operating or controlling the IP camera 104. In one embodiment, the memory 138 stores a public key 150 of the blockchain wallet 192 (FIG. 1) associated with the user account 114 (FIG. 1), and a public key 152 of a blockchain wallet 204 (FIG. 1) associated with the IP camera 104 itself. The memory 138 stores the encrypted image data 144, but not the unencrypted image data 130. The memory 138 includes, in one embodiment, an SD card, a USB memory device, and/or other removable storage medium. In another embodiment, the memory 138 includes an embedded non-volatile memory device, such as a solid-state hard drive and/or an embedded (i.e. non-removable) SD card.

The network device 142 is configured to operatively connect the IP camera 104 to the Internet via a wired or wireless data connection. In one embodiment, the network device 142 is operatively connected to the Internet through a local area network (LAN). Additionally or alternatively, the network device 142 is operatively connected to the Internet through a cellular network and/or a satellite network. Accordingly, the network device 142 provides the IP camera 104 with a wired and/or wireless connection to the Internet. In one embodiment, to increase the security of the IP camera system 100, the image data 130 is not transmitted via the network device 142, and instead the encrypted image data 144 is transmitted via the network device 142.

The processor 146 is a programmable processing device that performs various operations described herein by executing programming instructions stored in the memory 138. The processor 146 may suitably comprise at least one microprocessor and/or microcontroller.

As shown in FIG. 2, the secure hardware element 140, also referred to herein as a secure element, an SE, and/or a restricted access chip, includes a video encryption key 132, a cryptographic hardware acceleration engine 136 (also referred to herein as cryptographic engine), a private key 180 of the blockchain wallet 192, a private key 182 of the blockchain wallet 204, and a key encryption key 184. In one embodiment, the secure element 140 is a computer chip that is protected from unauthorized access, is used to run a limited set of applications, and stores confidential and cryptographic data. The secure element 140 is provided as a removable storage device (i.e. a universal integrated circuit card (UICC) and/or a micro SD card) and/or an embedded secure element chip (i.e. an “SE”). The data stored to the secure element 140 is encrypted. Accordingly, the secure hardware element 140 is configured to prevent unauthorized access to the video encryption key 132, the private key 180, the private key 182, and the key encryption key 184. None of the data stored to the secure element 140 can be accessed without proper authorization from the secure element 140. If the data stored to the secure element 140 was accessed without authorization, it would be useless to an attacker because it is encrypted. An exemplary secure hardware element 140 is available from NXP and is referred to as the EdgeLock SE050, which offers enhanced Common Criteria EAL 6+based security.

The cryptographic engine 136 includes a dedicated microcontroller 190 equipped with a cryptographic accelerator 194. The cryptographic accelerator 194 and the microcontroller 190 are configured to perform computationally intensive cryptographic operations much more electrically efficiently and time efficiently than a general-purpose processor, such as the processor 146. An exemplary cryptographic engine 136 includes the Intel AES-NI and the VIA PadLock; however, the cryptographic engine 136 may be provided as any suitable device.

The cryptographic engine 136 is configured to encrypt the image data 130 generated by the image sensor 134 to generate the encrypted image data 144. In one embodiment, the IP camera 104 utilizes the cryptographic engine 136 when the IP camera 104 is initialized and configured by the user 176 (FIG. 1) via a mobile app 188 (FIG. 1) on the smartphone 108 to encrypt the image data 130 generated by the image sensor 134. For example, the IP camera 104 generates a short video clip (e.g., ten seconds) of the image data 130. Immediately, the image data 130 is processed by the cryptographic engine 136 to generate the encrypted image data 144. The encrypted image data 144 is then stored either in the memory 138 or on the remote IoT cloud 116 (FIG. 1) each time a motion is detected. The unencrypted image data 130 is not stored by the IP camera system 100. In one embodiment, the user 176 receives an alarm in response to motions detected by the IP camera 104, and the user 176 can replay the stored video clip using the mobile app 188 on the smartphone 108. The image data 130 is encrypted quickly and without stressing the processor 146 by using the cryptographic engine 136 of the secure hardware element 140.

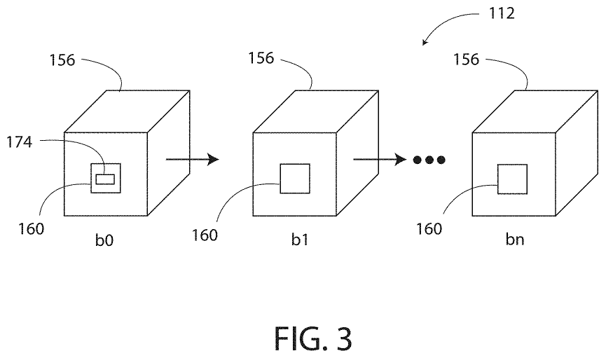

With reference to the simplified block diagram of FIG. 3, the blockchain 112 includes a chronological linked sequence of data blocks 156 (b0, b1, . . . , bn) that each store data in electronic storage files 160. New blocks 156 are appended to the blockchain 112 by mutually distrustful peer computers 170 (FIG. 1, also referred to herein as nodes, node devices, and mining nodes) through a mining process. To initiate the mining process, transaction clients, such as the IP camera 104 and the smartphone 108, broadcast transactions to specific node devices 170 in the peer-to-peer service 120 on which the blockchain 112 is distributed. The specific nodes 170 check the validity of received transactions, generate a new block 156 with valid transactions, and perform a consensus mechanism amongst themselves to append the new block 156 to the blockchain 148.

The blockchain 112 is a tamper-evident and tamper-resistant digital ledger implemented in a distributed fashion (i.e., without a central repository) and, typically, without a central authority (i.e., a bank, company, or government). As noted above, the blockchain 112 is used to record transactions in an order agreed to by a consensus of the peer computers 170 in the network of the peer-to-peer service 120 (FIG. 1). The blockchain 112 is maintained and shared across the decentralized peer-to-peer service 120 made up of a cluster of the participating node devices 170. The blockchain 112 eliminates trusted intermediaries by requiring transactions to be verified by the computers 170. In particular, a distributed consensus protocol, which tolerates faults and adversarial attacks, ensures that all the computers 170 agree on a unique order in which the data blocks 156 are appended. As a result, trust in the blockchain 112 is not placed on any individual, but rather is placed in the blockchain 112 as a whole. The blockchain 112 provides an infrastructure where trust is embodied algorithmically in the transaction itself and effectively liberates data that was previously kept in safeguarded silos. Moreover, the blockchain 112 enforces IP camera 104 ownership, facilitates IP camera 104 sharing, and ensures data integrity of cloud storage on the IoT cloud 116.

The blockchain 112 of the IP camera system 100 is configured to execute smart contracts 174 (FIG. 3). The smart contract 174, as that term is used herein, refers to computer transaction protocols that execute the terms of a contract automatically based on a set of conditions. In the context of the blockchain 112, the smart contract 174 represents computer or program code that is stored, verified, and executed on the blockchain 112 in one of the storage files 160, for example. While the blockchain 112 contains the electronic storage file 160 including the smart contract 174, a network of miners, such as the computers 170, execute business logic of the smart contract 174 and update the blockchain 112 by reaching a consensus.

Users invoke the smart contract 174 by sending transactions to a blockchain address of the smart contract 174. Each transaction triggers a state transition of the smart contract 174, with data being written to the smart contract 174 and stored in a corresponding storage file 160. During the run-time, the smart contract 174 performs predefined logic and may also interact with other computers 170, accounts (e.g. the user account 114), and smart contracts 174 by sending messages (i.e., calls to other smart contracts 174) or transferring funds. As self-executing codes on the blockchain 112, smart contracts 174 streamline processes that are currently spread across multiple parties and systems.

With reference again to FIG. 1, the IoT cloud 116 includes a remote server 202 operably connected to electronic storage 206 that includes the user account 114 stored thereon. The remote server 202 is configured for management of the user account 114, management of the IP camera 104, and data storage. The IoT cloud 116 includes computer nodes (not shown) configured to receive, transmit, and store digital data in the electronic storage 206 using the server 202. The server 202 is configured to process data for authenticating client devices 108, 112 to communicate with the user account 114, and for binding the client devices 108, 112 to the user account 114, among other functions and operations.

As shown in FIG. 1, the user account 114 stored on the electronic storage 206 of the IoT cloud 116 includes the encrypted image data 144 corresponding to video clips and/or images uploaded from the IP camera 104 and/or the smartphone 108, a random challenge generator 216, user account registration information, and ownership information of the IP camera 104 received from the blockchain 112. As controlled by the server 202, the IoT cloud 116 provides remote storage, and serves requests from the user 176 for retrieving video clips and images (i.e. the encrypted image data 144). The retrieved video clips and images are transmitted in an encrypted format to the smartphone 108, for example. As noted below, the encrypted image data 144 may also be transmitted through the P2P service 120 as an intermediary between the IoT could 116 and the smartphone 108 or the IP camera 104.

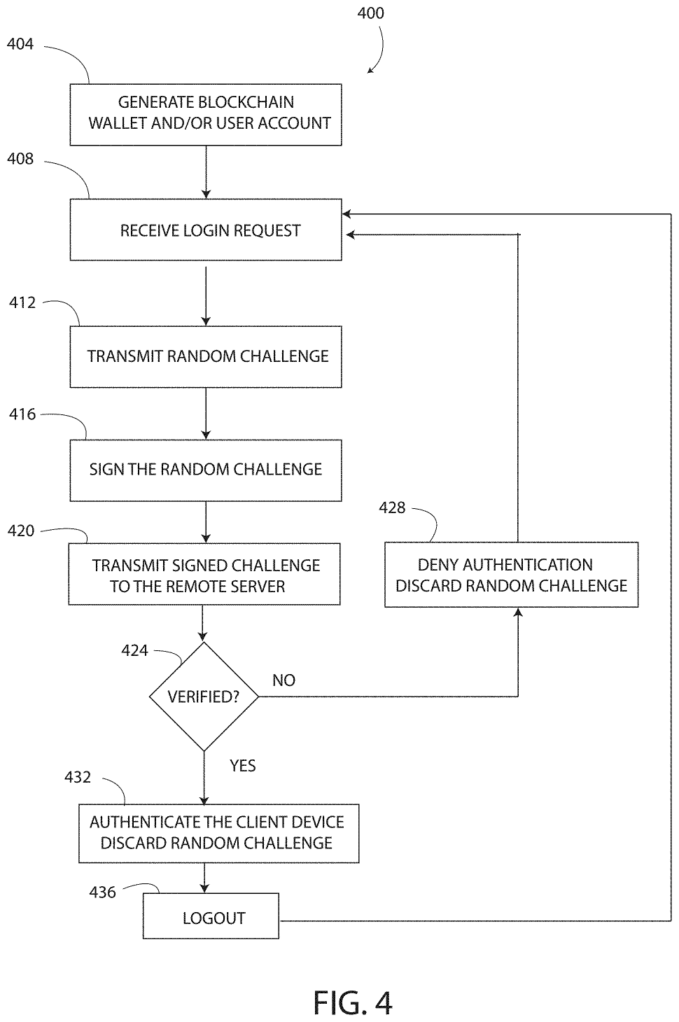

The random challenge generator 216 is configured to generate and/or to store a plurality of random challenges 220 that are used to authenticate the user 176 when the user 176 requires access to the user account 114. Accordingly, the random challenges 220 are part of a challenge-response authentication protocol, as described herein. In an exemplary embodiment, the random challenge 220 includes a random string of numbers and letters, referred to herein as a cryptographic nonce, that is provided to the smartphone 108. The smartphone 108 applies a known rule to the nonce and returns the result (i.e. an authentication response) to the user account 114 via the Internet. The server 202 compares the result from the smartphone 108 to a known result. The smartphone 108 successfully completes the random challenge 220 (and is authenticated) when the returned result matches and/or corresponds to the known result. The smartphone 108 fails the random challenge 220 (and is not authenticated) when the returned result does not match and/or does not correspond to the known result. The random challenge 220 and usage thereof are described in detail herein in connection with the method 400 of FIG. 4.

As noted above and with reference again to FIG. 1, the user account 114 has an associated blockchain wallet 192 stored on the blockchain 112. The blockchain wallet 192 has a corresponding unique address 198 on the blockchain 112 and is stored as the data 160 (FIG. 3) on the blockchain 112, for example. The blockchain wallet 192 is configured to store public and/or private cryptographic keys, cryptocurrencies, and other digital data, referred to herein as elements 196 of the wallet 192. The blockchain wallet 192 is further configured to track ownership, receive, and/or spend cryptocurrencies, for example. The blockchain address 198 is also referred to herein as the blockchain address of the user account 114.

The blockchain wallet 192 includes at least two variables; namely, the public cryptographic key 150 (FIG. 2) and the private cryptographic key 180 (FIG. 2). The public cryptographic key 150 enables other blockchain wallets of the blockchain 112 (such as a blockchain wallet 204 of the IP camera 104) to deposit funds or to transfer the elements 196 into the blockchain wallet 192. The public cryptographic key 150 is publically exchangeable and may be safely stored on any storage device. As shown in FIG. 2, the public key 150 is stored to the memory 138. In other embodiments, however, the public key 150 may be stored to the secure element 140.

The private key 180 of the blockchain wallet 192 associated with the user account 114 enables the spending of cryptocurrencies from the blockchain wallet 192 and the transfer of the elements 196 out of the blockchain wallet 192. As shown in FIG. 2, the private key 180 is stored only in the secure element 140 of the IP camera 104. Accordingly, the private key 180 is stored in an encrypted format and cannot be accessed by an adversary due to the security provided by the secure element 140. In another embodiment, the private key 180 is stored in a secure element (not shown) of the smartphone 108. The private key 180 is not publically exchangeable and is kept secret by the user 176. Accordingly, the private key 180 is not stored to the memory 138, which has the potential for being compromised by an adversary.

As shown in FIG. 1, in some embodiments, the IP camera 104 also includes an associated blockchain wallet 204 stored on the blockchain 112. The blockchain wallet 204 has a corresponding unique address 234 on the blockchain 112 and is stored as the data 160 (FIG. 3) on the blockchain 112, for example. The blockchain wallet 204 is configured to store public and/or private cryptographic keys, cryptocurrencies, and other digital data, referred to herein as elements 230 (FIG. 1) of the wallet 204. The blockchain wallet 204 is further configured to track ownership, receive, and/or spend cryptocurrencies, for example. The blockchain address 234 is also referred to herein as the blockchain address of the IP camera 104.

The blockchain wallet 204 includes at least two variables; namely, the public cryptographic key 152 (FIG. 2) and the private cryptographic key 182 (FIG. 2). The public cryptographic key 152 enables other blockchain wallets of the blockchain 112 (such as the blockchain wallet 192 of the user account 114) to deposit funds or to transfer the elements 230 into the blockchain wallet 204. The public cryptographic key 152 is publically exchangeable and may be stored safely on any storage device. As shown in FIG. 2, the public key 152 is stored to the memory 138. In other embodiments, however, the public key 152 may be stored to the secure element 140.

The private key 182 of the blockchain wallet 204 of the IP camera 104 enables the spending of cryptocurrencies from the blockchain wallet 204 and the transfer of the elements 230 out of the blockchain wallet 204. As shown in FIG. 2, the private key 182 is stored in the secure element 140 of the IP camera 104. Accordingly, the private key 182 is stored in an encrypted format and cannot be accessed by an adversary due to the security provided by the secure element 140. In another embodiment, the private key 182 is stored in a secure element (not shown) of the smartphone 108. The private key 182 is not publically exchangeable and is kept secret by the user 176. Accordingly, the private key 182 is not stored to the memory 138, which has the potential for being compromised by an adversary.

As shown in FIG. 1, the P2P service 120 simplifies the linkage between the IP camera 104 and the smartphone 108 when a user 176 views camera feeds locally or remotely. That is, the P2P service 120 facilitates the streaming of encrypted data from the IP camera 104 to the smartphone 108. As noted above, the P2P service 120 includes a network of computer nodes 170 each operably connected to the Internet for electronic communication with the IP camera 104, the smartphone 108, the blockchain 112, and the IoT cloud 116. The user 176 can request to view live streaming videos through the P2P service 120. The electronic data of the live streaming videos is transmitted by the P2P server 120 in an encrypted format.

With reference to FIG. 1, the smartphone 108, which is also referred to herein as a client device, includes a display 178 and an input device 186 and is configured to execute a mobile app 188 to facilitate the user 176 in configuring the IP camera 104, uploading encrypted data to the user account 114 of the IoT cloud 116, and retrieving encrypted data from the user account 114 of the IoT cloud 116. The smartphone 108 is further configured to display videos and images associated with the encrypted image data 144 on the display 178. Moreover, the smartphone 108 is configured to display captured video clips and live streaming videos on the display 178, and to share the encrypted image data 144 with other smartphones 108 via the Internet.

The display 178, in one embodiment, is a liquid crystal display (LCD) panel configured to render and to display text, images, and other user sensible outputs and visually comprehensible data. For example, the display 178 is configured to render data, such as a graphical user interface (GUI) for controlling the IP camera 104, for managing the blockchain wallet 192, and for retrieving and sending encrypted data to the IoT cloud 116.

The input device 186 is a touchscreen applied to the display 178 that is configured to respond to the touch of a finger or a stylus by generating user input data. In another embodiment, the input device 186 includes at least one button that is configured to generate input data when touched or moved by a user. In yet another embodiment, the input device 186 is any device configured to generate an input signal and/or input data, as desired by those of ordinary skill in the art.

As shown in FIG. 1, the mobile app 188 of the smartphone 108 is further configured to link to, to operate, to manage, and/or to issue instructions for creating the blockchain wallet 192 and the blockchain wallet 204. The mobile app 188 is a program or application run by an operating system of the smartphone 108 and includes a corresponding graphical user interface (GUI) shown on the display 178. The blockchain wallets 192, 204 are accessible through the smartphone 108 using the mobile app 188. The mobile app 188 enables the user 176 to manage the elements 196, 230 stored in the wallets 192, 204. The elements 196, 230 stored in the wallets 192, 204 are not stored on the smartphone 108 or the IP camera 104, instead the elements 192, 204 of the wallets 192, 204 are stored on the blockchain 112 as the data 160.

The user 176 is the owner and/or operator of one or multiple IP cameras 104 and utilizes the mobile app 188 on the smartphone 108 to interact with the IP cameras 104.

In a typical home IP camera system, an adversary might try to compromise a user account system on a cloud server for taking over ownership of corresponding IP cameras. A nearby adversary may also launch attacks against a device binding process of the typical home IP camera and take control of the victim's device. In addition, an attacker might eavesdrop on wireless communications between the typical IP camera and cloud server. Moreover, a cloud provider could behave maliciously by viewing, inserting, deleting, and modifying the video clips stored thereto. Furthermore, an attacker may impersonate a legitimate user and try to access live streaming videos via a P2P service. The IP camera system 100 disclosed herein overcomes these issues and more, and is a user-centric, blockchain-based, and end-to-end secure home IP camera system 100.

In operation, the IP camera system 100 disclosed herein replaces the traditional username/password-based login approach with a one-click, passwordless login approach by leveraging the blockchain wallet 192 accessed through the mobile app 188 on the smartphone 108. The passwordless user authentication mitigates the risk of users choosing weak passwords, and minimizes the impact when the user account 114 is compromised on the IoT cloud 116. Besides improving the security and user experience of the login process, the IP camera system 100 thwarts various attacks against device binding via a camera-based out-of-band (OOB) channel and the resurrecting duckling security model. Such an approach enables the IP camera 104 to ‘see’ its owner and commit the ownership to the blockchain 112 directly.

Moreover, for protecting users' privacy, the system 100 realizes end-to-end encryption using user-specified secret keys for encrypting video clips and live streaming videos, which ensures that only the camera owners and their authorized entities can access the videos (i.e., the image data 130) captured by the owners' devices 104. To further improve data integrity of video clips, the IP camera system 100 configures the IP camera 104 to locally generate a data integrity proof (i.e., a Merkle root) for a set of video clips and commit it to the blockchain 112 periodically, which protects the video clips from storage errors and malicious attacks effectively. Given that both video clips and live streaming videos are encrypted, the IP camera system 100 further resolves sharing of video clips and live streaming videos using re-encryption with Intel SGX and key refreshing, respectively. These approaches and concepts are described more fully herein.

### Passwordless Login

With reference to FIG. 4, a method 400 of authentication (i.e. a login process) for the IP camera 104 and the user account 114 is disclosed. Passwords are a problematic method for user authentication with respect to usability and security. To thwart potential credential stuffing attacks and to improve user experience, the mobile app 188 utilizes the private/public key pair 150, 180 associated with the blockchain wallet 192 of the user account 114 to implement passwordless login to the user account 114.

As shown in block 404, the method 400 includes generating at least one of the user account 114 and the blockchain wallet 192 using the mobile app. In one embodiment, when the user 176 opens and/or initiates the mobile app 188 for the first time, the mobile app 188 generates the blockchain wallet 192 on the blockchain 112 automatically. Such an approach includes storing the private key 180 in the secure element 140 of the IP camera 104. Moreover, the blockchain address 198 of the wallet 192, which is derived and/or generated from the public key 150 of the wallet 192, is passed to the IoT cloud 116 and is used to create the user account 114 on the remote server 202. In one embodiment, the user account 114 is identified and referenced on the storage 206 by the blockchain address 198 of the blockchain wallet 192. Moreover, the public key 150 of the blockchain wallet 192 is also transmitted to the IoT cloud 116 and stored as part of the user account 114.

Next in block 408, the IP camera system 100 receives a login request for logging onto the user account 114. The login request may be transmitted from the smartphone 108 to the remote server 202 and/or from the IP camera 104 to the remote server 202. For example, the login request is transmitted from the smartphone 108 to the remote server 202 of the IoT cloud 116 when the user 176 wants to use the smartphone 108 to retrieve the encrypted image data 144 from the storage 206. In another embodiment, the login request is transmitted from the IP camera 104 to the remote sever 202 of the IoT cloud 116 when the encrypted image data 144 is to be updated from the IP camera 104 to the remote storage 206.

In one embodiment, during the login request process, the GUI of the mobile app 188 displays a corresponding input, such as a “LOGIN” virtual button on the display 178. To generate and transmit the login request, the user 176 need only to select the virtual button by touching the input device 186, which is typically provided as the touchscreen.

Next at block 412 of the method 400, a random challenge 220 is transmitted from the remote server 202 to the client device (i.e. either the smartphone 108 or the IP camera 104) when the remote server 202 receives the transmitted login request. For example, in one embodiment, when the user 176 selects the virtual “LOGIN” button, the mobile app 188 makes an application program interface (API) call to the IoT cloud 116 for retrieving a fresh and never before used random challenge 220 from the random challenge generator 216 associated with the user account 114. The random challenge generator 216 updates and changes the random challenge 220 after each login attempt to thwart replay attacks.

The random challenge generator 216 and the associated random challenges 220 are associated with only the user account 114 and are associated with no other user account, such that each user account 114 has different and unique random challenges 220. For example, the rule(s) applied to the cryptographic nonce is different for each user account 114. Moreover, a different random challenge 220 is transmitted for each login request received by the remote server 202; accordingly, no random challenge 220 is used more than once.

At block 416, the client device signs the random challenge 220. The signature applied to the random challenge 220 is based on the private key 180 of the blockchain wallet 192 and the corresponding rule(s) of the random challenge. For example, the random challenge 220 may require the client device to generate a hash based on the random challenge 220 (i.e. the nonce) and the private key 180. The resulting hash is the signed random challenge 220. The signed random challenge 220 is also referred to herein as an authentication response.

From the user perspective, the random challenge 220 is signed by touching a corresponding virtual button of the GUI of the mobile app 188 as shown on the display 178, such as a “SIGN” virtual button. Accordingly, the smartphone 108 displays visual information associated with the random challenge 220 on the display 178. The displayed visual information requests the user to electronically “sign” the random challenge 220. The user 176 signs the random challenge 220 with a single tap on the “SIGN” virtual button or any other appropriately labeled designated area of the GUI of the mobile app 188, and the input device 186 generates corresponding user input data. Accordingly, the user 176 need not remember any passwords to sign the random challenge 220. The user input and/or the input data instructs the smartphone 108 (i.e. a type of client device) to sign the random challenge 220. In response to detecting the user input, a processor of the smartphone 108 signs the random challenge 220.

When signed by the user, at block 416, the mobile app 188 generates a corresponding signature and corresponding signature data. In one embodiment, the signature includes at least the signed random challenge 220 and the blockchain address 198 of the blockchain wallet 192 of the user account 114. The signature may include any other suitable information in other embodiments. If the random challenge 220 is not signed by the user 176, then the authentication process of method 400 is terminated.

Next, at block 420, the signature is transmitted to the remote server 202 of the IoT cloud 116. In particular, the signed random challenge 220 and the blockchain address 198 are transmitted to the remote server 202. The blockchain address 198 is transmitted to the remote server 202 so that the remote service 202 is able to identify the particular user account 114 with which the signature is associated/directed to.

At block 424 of the method 400, the server 202 verifies or attempts to verify the transmitted signature. Verification occurs when the signed random challenge 220 corresponds to the transmitted random challenge 220. Verification does not occur when the signed random challenge 220 does not correspond to the transmitted random challenge 220. In one embodiment, when the IoT cloud 116 receives the signed random challenge 220, the server 202 looks up the corresponding user account 114 using the blockchain address 198 of the wallet 192 and obtains/identifies the transmitted random challenge 220 that was sent to the smartphone 108. Then, verification is performed by comparing the signed random challenge 220 from the smartphone 108 to the random challenge 220 received by the IoT cloud 116. For example, during the authentication, the IoT cloud 116 decrypts the signed random challenge 220 with the public key 150 of the blockchain wallet 192. Verification occurs when the decrypted random challenge 220 transmitted from the smartphone 108 matches and/or corresponds to the random challenge 220 received by the IoT cloud 116. In other embodiments, any other suitable process is used to verify the signed random challenge 220.

At block 428 when the verification at block 424 does not occur, then the method 400 returns to block 408 to wait for a subsequent login request. Moreover, the random challenge 220 that was transmitted at block 412 is deleted and is never used again. When the verification does not occur, authentication of the client device is denied and the user 176 is prevented from accessing the data of the user account 114. That is, the denied authentication prevents the smartphone 108 and/or the IP camera 104 from accessing and/or adding to the data associated with the user account 114 including at least the encrypted image data 144.

At block 432 when the verification at block 424 occurs, the client device is authenticated, is logged into the user account 114, and can access and add to the data of the user account 114 including at least the encrypted image data 144. The IoT cloud 116 transmits the data stored in the user account 116 to the client device only when the verification succeeds.

In some embodiments, after a successful verification at block 424, a JavaScript Object Notation (JSON) Web Token (JWT) (i.e. an exemplary access token) is transmitted from the remote server 202 to the client device for accessing the storage 206 of the IoT cloud 116 that is associated with the user account 114. The access token has a limited lifespan (i.e. a predetermined time period) and the client device can access the data of the user account 114 during the lifetime of the access token. When the lifespan of the access token expires, then the client device is no longer authenticated and the client device can no longer access the data of the user account 114. As shown at block 436, the user 176 is logged out when the access token expires. Any other suitable type of digital access token may be used by the system 100 to control access of the authenticated client device to the data of the user account 114.

In the method 400, each transmitted random challenge 220, whether signed or not, is never used again to increase the security of the system 100. This feature is noted at blocks 428 and 432, which delete the random challenge 220 both when verification is successful and when verification is unsuccessful.

The login process/authentication process described by the method 400 of FIG. 4 leverages asymmetric cryptography and blockchain technology to eliminate the need for cumbersome passwords, thereby achieving better usability and security than the traditional username/password-based approach. The user is provided with a fast and easy process that is far more secure than the username/password-based approach and is far more convenient than typical two-factor authentication approaches. In particular, the IP camera system 100 leverages the blockchain wallet 192 of the user account 114, which is securely generated on the mobile app 188, as well as asymmetric cryptography to realize a one-click, passwordless user authentication mechanism, which eliminates the usage of passwords in the login process and mitigates the impact of a data breach.

### Ownership Management

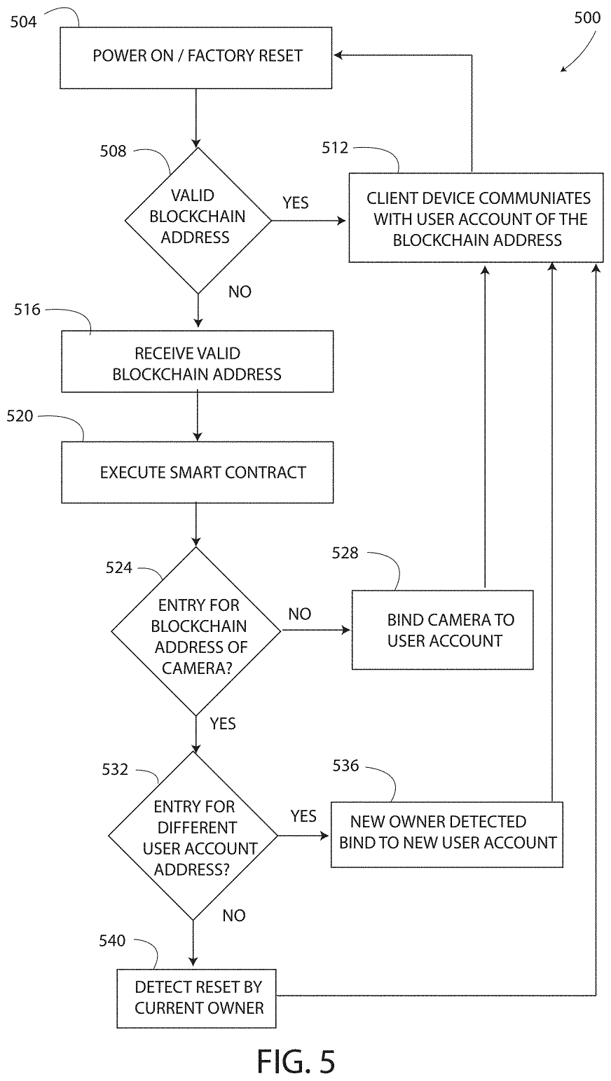

With reference to FIG. 5, the IP camera system 100 is configured to apply a blockchain-based ownership management method 500 for securely and conveniently binding the IP camera 104 (i.e. an exemplary client device) with the corresponding user account 114. The method 500 binds the IP camera 104 with the user account 114 through an out-of-band (OOB) channel and applies an implementation of the “resurrecting duckling security model.” The resurrecting duckling security model is based on the following metaphor: baby ducklings follow the first moving object they see after hatching, especially if it makes duck sounds. This attachment development process is called “imprinting.”

At block 504, the method 500 includes powering on the IP camera 104 for the first time or resetting the IP camera 104 to a factory default state by pressing a corresponding reset button of the IP camera 104.

Next, at block 508, the IP camera 104 searches the memory 138 to locate a valid blockchain address 198 of a corresponding user account 116 already stored in the memory 138. The blockchain address 198 is derived from and/or included in the public key 150. As noted above, when the user account 116 is created, it is created based on the blockchain address 198 of the corresponding blockchain wallet 192.

At block 512, when a valid blockchain address 198 of the user account 114 is located in the memory 138, then the IP camera 104 is bound to the corresponding user account 114. When the IP camera 104 is bound to the corresponding user account 114, the IP camera 104 is configured to transmit data to the user account 114 for storage and also to retrieve stored data of the user account 114 including but not limited to the encrypted image data 144.

At block 516, if a valid blockchain address 198 of a user account 114 is not located in the memory 138, then the user 176 is prompted to provide a valid blockchain address 198 of the user account 114 to the IP camera 104. Without a valid blockchain address 198 of a user account 114 the IP camera 104 will not communicate with any user account 114. The user 176 provides the blockchain address 198 to the IP camera 104 using any suitable means.

In a specific embodiment at block 516, the blockchain address 198 of the user account 114 is encoded into a visual code 238 (FIG. 1) shown on the display 178 of the smartphone 108 by the mobile app 188. An exemplary visual code 238 is a one-dimensional barcode, a two-dimensional barcode (i.e. a QR code (see FIG. 1)), or another suitable code. Next, the user 176 holds the display 178 in front of the image sensor 134 of the camera 104 so that the camera 104 reads in the displayed code 238 by generating image data 130 corresponding to the visual code 238. The image data 130 is processed by the processor 146, and the blockchain address 198 of the user account 114 and/or the public key 150 is extracted from the visual code 238 and stored in the memory 138 and/or the secure element 140.

At block 520 of the method 500, after receiving the blockchain address 198 of the user account 114, the camera 104 invokes and executes an ownership management smart contract 174 (FIG. 3) on the blockchain 112 (as soon as an Internet connection is available). Access to the Internet is provided by connecting the network device 142 to a wired Internet connection or by connecting the network device 142 to a wireless Internet connection. The ownership management smart contract 174 is deployed on the blockchain 112 by the manufacturer of the IP camera 104, for example. The smart contact 174 receives at least two parameters before being automatically executed including the blockchain address 234 of the IP camera 104 and the blockchain address 198 of the user account 114. The IP camera 104 is configured to transmit the blockchain address 198, 234 to the blockchain 112 and specifically to the smart contract 174.

The IP camera 104 determines the appropriate user 176 for ownership of the IP camera 104 by creating an association of the blockchain address 234 of the IP camera 104 with the blockchain address 198 of the user account 114 on the blockchain 112. Accordingly, the IP camera 104 “imprints” on the first valid blockchain address provided thereto, much the same as the metaphorical “duckling.”

In blocks 524 and 528, during the execution of the smart contract 174, if the smart contract 174 does not have an entry containing the blockchain address 234 of the IP camera 104 (such as when the IP camera 104 is new and is activated for the first time), then a new entry associating the blockchain address 234 of the IP camera 104 with the user blockchain address 198 of the user account 114 is created in the smart contract 174 on the blockchain 112. In this way, an initial owner 176 is detected and execution of the smart contract 174 binds the IP camera 104 to the user account 114 of the initial owner 176.

In a specific embodiment at block 524 and 528, execution of the smart contract 174 results in the generation of a bind request. The instructions of the smart contract 174 cause the computer 170 executing the smart contract 174 to transmit the bind request to the IoT cloud 116 for processing by the remote server 202. The transmitted bind request identifies the user account 114 based on the blockchain address 198 and identifies the IP camera 104 based on the blockchain address 234. To perform the binding, the remote server 202 executes the bind request by storing the blockchain address 234 of the IP camera 104 in the data of the corresponding user account 114. In this way, the user account 114 and the IP camera 104 are further linked together (i.e. bound) by their corresponding blockchain addresses 198, 234. As noted at block 512, when the IP camera 104 is bound to the user account 114, data is transmittable between the IP camera 104 and the user account 114. When the IP camera 104 is not bound to the user account 114, then no data can be transmitted between the IP camera 104 and the user account 114.

At blocks 532 and 536, during the execution of the smart contract 174, if the smart contract 174 includes an entry associating the blockchain address 234 of the IP camera 104 with the blockchain address 198 of a different user account 116 (i.e. a first user account 116), then a new owner 176 is detected and a transfer of ownership of the IP camera 104 has occurred. In response, the smart contract 174 updates the blockchain 116 and the IoT cloud 112 to bind the IP camera 104 to the user account 116 (i.e. a second user account 116) associated with the blockchain address 198 provided at block 516. Accordingly, when the IP camera 104 is provided to another person, the new owner 176, establishes ownership by registering her user account 114 (i.e. the second user account 116) with the blockchain 112 and the IoT cloud 116 as controlled by execution of the smart contract 174. The smart contract 174 causes the IP camera 104 to bind to the second user account 116, and to unbind from the first user account 116 to prevent the IP camera 104 from accessing the first user account 116. In an embodiment, the IP camera 104 can be bound to only one user account 116 at a time.

At blocks 532 and 540, if an entry associating the blockchain address 234 of the IP camera 104 with the blockchain address 198 of a previously-provided user account 114 is included in the smart contract 174, then the IP camera 104 was reset by the current owner 176, and the smart contract 174 does not need to update the state.

The method 500 of FIG. 5, is a convenient and secure approach for binding the IP camera 104 to the user account 114 using the blockchain 112. Moreover, thanks to the ownership management with the smart contract 174 on the blockchain 112, an ownership transfer is easily and securely handled by the IP camera system 100. The IP camera system 100 adapts the resurrecting duckling security model to enable the IP camera 104 to claim the owner 176 directly and to bind such relationship on the blockchain 112, which enables management of device ownership in a decentralized manner and reduces the risk of the IP camera 104 and the user account 114 being taken over by attackers significantly.

### End-to-End Encryption

The IP camera system 100 uses end-to-end encryption coupled with a user-centric key management mechanism to ensure that only the owner 176 and authorized entities of the owner 176 can access the encrypted image data 144 and/or live streaming videos from the IP camera 104 and the IoT cloud 116. Specifically, the IP camera system 100 leverages end-to-end encryption to protect the confidentiality of both video clips and live stream videos.

In one embodiment, the image data 130 (i.e. raw video data) generated by the IP camera 104 is encrypted based on user-specified encryption keys (i.e. the video encryption key 132) using the hardware-based cryptographic engine (CE) 136 inside the secure element 140 of the IP camera 104, before the image data 130 is stored locally on an SD card (i.e., the memory 138), remotely on the IoT cloud 116, or sent to the P2P streaming service 120. As such, the cryptographic engine (CE) 136 prevents the storage of the unencrypted image data 130 in the memory 138 and/or the remote storage 206 of the IoT cloud 116.

Given a video frame (v) of (l) bits of the image data 130 and the video encryption key (k_{V}) 132, the cryptographic engine 136 encrypts the video frame (v) of the image data 130 as follows:

v′=v⊕KSG (l, CE(kᵥ, IV)),

where KSG(·) is a keystream generator using the underlying cryptographic engine (CE) 136 and the l-bit keystream is XORed with the video frame (v) to generate the corresponding ciphertext (v′). Here the cryptographic engine (CE) 136 can be instantiated using a stream cipher or a block cipher operating on the stream cipher mode, and IV is an initialization vector. The ciphertext (v′) corresponds to the encrypted image data 144, which is stored in the memory 138 and/or the remote storage 206.

For enabling a user to update the video encryption key (k_{V}) 132 in a secure manner, the cryptographic engine 136 is configured to derive the key encryption key (k_{E}) 184 from the private key (priv_{U}) 180 of the blockchain wallet 192 according to the following:

k_{E}=KDF (privᵤ, OtherInput),

where KDF can be any standardized key-derivation function. “OtherInput,” in one embodiment, includes a random salt (i.e., a byte string), the length of the key encryption key (k_{E}) 184, and other context-specific data, depending on the choice of the key-derivation function KDF. In one embodiment, the key encryption key (k_{E}) 184 is derived immediately after the blockchain wallet 192 is created using the mobile app 188 and is transmitted to the IP camera 104 together with the blockchain address 198 via the visual code 238.

Upon receiving the key encryption key (k_{E}) 184, the IP camera 104 stores the key encryption key (k_{E}) 184 in the secure element 140.

When the user 176 would like to update and/or to derive the video encryption key (k_{V}) 132 a request to generate a new key is generated and provided to the IP camera 104 via the network device 142. In response to receiving the request, the IP camera 104 first generates a new video encryption key (k′_{V}) 132 on the mobile app 188 and then encrypts the new video encryption key (k′_{V}) 132 based on the key encryption key (k_{E}) 184 according to the following:

c=Enc(k_{E}, k′_{V}).

The ciphertext (c), corresponds to an encrypted version of the new video encryption key (k′_{V}) 132 and is sent to the IP camera 104 through a public channel and replaces the previous video encryption key (k_{V}) 132 in the secure element 140. As a result, subsequent video clips or live stream videos (i.e., the image data 130) will be encrypted with the new video encryption key (k′_{V}) 132. In one embodiment, the IP camera system 100 utilizes a first encryption key (k_{C}) to encrypt video clips and a different second encryption key (kₛ) to encrypt live streaming videos for accommodating the corresponding video-sharing mechanisms. The video encryption key (k_{V}) 132 can be either of the encryption keys (k_{C}) and (k_{S}).

Next, for ensuring data integrity of video clips stored locally on an SD card (i.e., the memory 138) or remotely on the cloud storage (i.e., IoT cloud 116 or P2P service 120), the IP camera system 100 configures the IP camera 104 to commit integrity checkpoints to the blockchain 112 according to a user-defined time period. In one embodiment, the IP camera system 100 utilizes the blockchain 112 as a data integrity assurance layer and allows the IP camera 104 to commit integrity checkpoints to the blockchain 112 for protecting video clips from being arbitrarily altered. The user enables the data integrity protection feature via the mobile app 188, for example, and specifies the time period in days, in one embodiment, for checkpoint commitments, followed by topping up the blockchain wallet 192 associated with the user account 114 with a suitable amount of cryptocurrency tokens. Note that the shorter the time period is set, the more checkpoints the camera 104 is going to commit on the blockchain 112, thereby costing more of the cryptocurrency tokens stored in the wallet 192.

### Data Integrity Protection

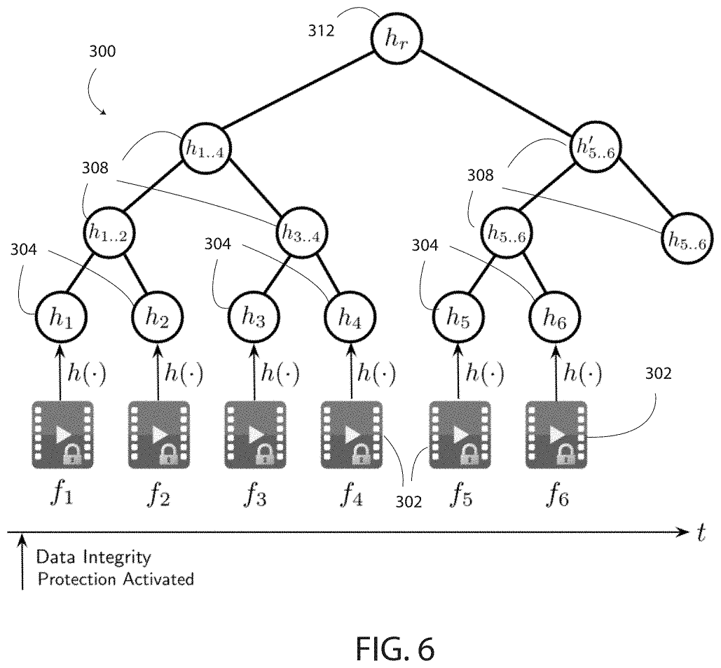

With reference to FIG. 6, Merkle trees 300 are used to link a set of data (i.e., image data 130) to a unique hash value (hᵣ) and, therefore, provide an efficient way to verify the integrity and freshness of video clips 302 of the image data 130 without retrieving the entire dataset from an untrusted server. Given a set of messages, such as the video clips 302, a client device (i.e., the IP camera 104 and/or the smartphone 108) builds a Merkle tree 300 as an authenticated data structure, where each leaf node 304 of the tree 300 contains the cryptographic hash (hₙ) of a message and each non-leaf node 308 contains the concatenated hashes (h_{n . . . n}) of its child nodes. After the Merkle tree 300 is created, the IP camera 104 keeps the root 312 of the tree 300 (i.e., the Merkle root 312) as a local proof

Upon verifying the correctness and freshness of a message on a server, the IP camera 104 retrieves the message and its siblings in the Merkle tree 300, which allows the IP camera 104 to recompute the Merkle root 312 locally without downloading all the messages. The IP camera 104 then compares this purported Merkle root 312 with the Merkle root 312 stored as the local proof. If they are equal, it indicates that the message is correct and fresh. Otherwise, the message has been altered due to system errors or malicious attacks.

After the data integrity protection feature is activated, the IP camera 104 builds a Merkle tree 300 dynamically for the encrypted video clips 302 received during the user-specified time period. FIG. 6 illustrates the Merkle tree 300 when six (6) encrypted video clips 302 have been processed. At the end of each time period, the IP camera 104 invokes another manufacturer deployed smart contract 174, which is responsible for checkpoint management, with parameters (idₘₜ; num; hᵣ), where iₘₜ is the Merkle tree 300 identifier that is concatenated with a file identifier to indicate which Merkle tree 300 the file belongs to. The hash (hᵣ) is the root 312 of the Merkle tree 300 built from num encrypted video files 302 and acts as the integrity checkpoint for the past time period.

As soon as integrity checkpoints become available on the blockchain 112, the user 176 is able to verify data integrity of encrypted video clips 302 retrieved from the memory 138 or the remote storage 116. After the user 176 sends a request for downloading an encrypted video clip 302 from the memory 138 and/or the remote storage 116, the IP camera 104 and/or the server 202 first identifies all the encrypted video clips 302 that are in the same Merkle tree 300 as the one in question using the Merkle tree identifier idₘₜ, followed by the generation of the corresponding Merkle path. The encrypted video clip 302 and Merkle path are then returned to the mobile app 188. Before decrypting the video clip 302, the mobile app 188 obtains the hash (hᵣ) from the smart contract 174 and verifies data integrity of the received video clip 302 using the hash (hᵣ) and the Merkle path, as described above. In this way, the user 176 is confident that the video clip 130 has not been altered in any way.

### Secure Video Clip Sharing

Next, considering the limited video-sharing scenarios of a typical camera, the IP camera system 100 implements a fine-grained secure video clip sharing scheme through a re-encryption process using Intel SGX technology. This technique can also be adapted to the video clips (image data 144) stored on the SD card (i.e., memory 138) by leveraging the key encryption key 184 and the hardware-based cryptographic engine 136 of the IP camera 104.

The Intel Software Guard Extensions (SGX) is a set of new x86 instructions provided in newer lines of Intel CPUs (6th generation and newer) that allows application developers to protect sensitive data from unauthorized modification and access from rogue software running at higher privilege levels. SGX aims to provide a trusted execution environment (TEE) for user-space applications by enabling code isolation within virtual containers called enclaves. The program running inside an enclave is cryptographically measured and the generated proofs by the enclave can be reported back to the client device, thereby enabling the trusted execution of software applications to a remote and untrusted platform.

Enclaves feature three salient security properties, namely isolation, sealing, and attestation. Isolation means that programs and data inside an enclave cannot be read/modified by other processes running at the same or higher privilege levels. On the other hand, sealing is the process of encrypting enclave secrets for persistent storage to disk, which uses authenticated encryption (i.e., AES-GCM) and thus allows the enclave to detect whether the sealed data has been modified externally. Finally, attestation enables an enclave to cryptographically prove that it is a genuine SGX enclave running on an up-to-date platform. SGX provides two forms of attestation mechanisms: local and remote. While local attestation allows two enclaves on the same platform to attest to each other, remote attestation generates an enclave-specific report called a “quote” that can be verified by a remote entity. Note that a secure communication channel can be established on top of the local/remote attestation process between two enclaves or between an enclave and a remote entity.

In one embodiment, the IP camera 104 creates a data-sharing enclave DataShare on the server 202 of the IoT cloud 116, which is responsible for re-encrypting the video clip(s) (i.e. the encrypted image data 144) selected by the user 176 for sharing. After the server 202 is started, it is ready to serve the data sharing requests from the user(s) 176. The video clip sharing process works as follows. Whenever the user 176 wants to share the video clip(s) (see FIG. 6) with others, the mobile app 188 performs a remote attestation with the DataShare enclave to verify that the application server 202 has loaded the correct code into the enclave. During this process, a symmetric session key (kₛₑ) is generated using the mobile app 188 and the DataShare enclave, thereby establishing a secure channel between two entities, such as the IoT cloud 116 and the smartphone 108.

After the user selects n video clip(s) on the mobile app 188 and sets a video sharing key (kₛₕ), the list of video file identifiers {id_{fl}; . . . ; id_{fn}}, the video sharing key (kₛₕ), and the video clip encryption key (k_{C}) 132 are encrypted using the session key (kₛₑ) and sent to the application server 202.

The application server 202 sends the received information to the DataShare enclave for decryption and retrieves n encrypted video clip(s) from the storage 206 of the IoT cloud 116 using the identifier list {id_{fl}; . . . ; id_{fn}}. The retrieved n video clip(s) are then decrypted and re-encrypted inside the DataShare enclave using the video clip encryption key (k_{C}) and the video sharing key (kₛₕ), respectively.

The application server 202 stores the re-encrypted video clip(s) in the cloud storage 206 and returns the Uniform Resource Identifier (URI) to the mobile app 188. The user 176 is then able to share the URI and video sharing key (kₛₕ) with others through various communication channels (e.g., visual code 238, QR code, email, etc.).

To save costs for using cloud storage, the URI for the shared video clip(s) is only valid for a user-defined amount of time and all the shared video clip(s) will be deleted thereafter. The above secure data sharing scheme enables the user 176 to fully control which video clip(s) to share with different entities, thereby minimizing the potential data leakage.

### Secure Live Streaming

The IP camera system 100 is configured to secure the image data 130 for secure live streaming and video sharing using key refreshing. Due to the real-time requirements for sharing live streaming videos, in one embodiment, the IP camera system 100 uses key refreshing instead of re-encryption for sharing the image data 130 generated by the IP camera 104 with other client devices and users. More specifically, in one embodiment, the device owner 176 directly sends the current live streaming video encryption key (k_{S}) 132 to all the entities with which he/she would like to share the IP camera 104. Whenever the device owner 176 decides to revoke access for one or multiple people, the system 100 generates a new live streaming video encryption key (k′_{S}) 132 is which is distributed to the entities. Moreover, the device owner 176 also updates the live streaming video encryption key (k_{S}) 132 on the IP camera 104 as described in the end-to-end encryption discussion. Note that the distribution of a live streaming video encryption key k_{S} 132 to multiple recipients can be done securely by encrypting it with their corresponding public keys. The device owner 176 obtains a public key via an email or by scanning a visual code on the recipient's mobile app, respectively. Since the IP camera 104 system utilizes two different keys for encrypting video clips and live streaming videos (i.e. encryption keys (k_{C}) and (k_{S})), the confidentiality of video clips is well protected.

In addition to distributing the live streaming video encryption key (k_{S}) 132, the IP camera 104 also generates access tokens (TK_{OR}) for authorizing other entities to retrieve live streaming videos stored as the encrypted image data 144 via the P2P service 120. An access token (TK_{OR}) is a tuple (pub_{O}; addr_{R}; addr_{C}; Tₑₓₚ, Sign_{privO} (addr_{R}; Tₑₓₚ)), where pub_{O} is the device owner's public key 150, addr_{R} is a blockchain address of the requestor's IP camera 104, and addr_{C} denotes the blockchain address 234 of the IP camera 104 of the user 176. The value Tₑₓₚ is an expiry time of the access token and the value Sign_{privO} (addr_{R}; addr_{C}; Tₑₓₚ) is the signature of the user 176. A data requester can retrieve live streaming videos with the access token by sending a connection request to the P2P service 120 by presenting his/her public key (pub_{R}) and the access token (TK_{OR}). Then, the P2P service 120 verifies the validity of the access token (TK_{OR}) by (i) checking Tₑₓₚ to ensure that the access token (TK_{OR}) is not expired; (ii) querying the ownership management smart contract 174 with the blockchain address (addr_{C}) 234 of the IP camera 104 of the user 176 to obtain the blockchain address (addr_{O}) 198 of the user 176; (iii) checking that addr_{O} and addr_{R} are derived from the public keys (pub_{O}) and (pub_{R}), respectively; and (iv) verifying that the signature Sign_{privO} (addr_{R}; addr_{C}; Tₑₓₚ) is valid. If any of the above verification steps fail, the P2P service 120 rejects the connection request.

Next, the P2P service 120 sends a random challenge (r_{P}) to the requester for verifying that he/she is the owner of the blockchain address (addr_{R}). The requester generates the signature Sign_{privR} (r_{P}) and sends it to the P2P service 120 as the response. The P2P service 120 verifies the validity of the signature Sign_{privR} (r_{P}) and then grants or rejects the P2P service 120 from the requester accordingly. Based on the above, the IP camera system 100 facilitates sharing of encrypted video clips and live streaming videos via re-encryption with Intel SGX and key refreshing, respectively, which enables users 176 to realize fine-grained access control for the device data such as the encrypted image data 144.

The IP camera system 100 described herein is a user-centric, blockchain-based and end-to-end secure IP camera system. When compared to other IP camera solutions, the IP camera system 100 offers strong security and privacy protection for multiple core functionalities, including user login, device binding, device ownership management, video confidentiality, storage integrity, and video sharing. By leveraging blockchain technology, the IP camera system 100 supports passwordless user authentication and protects cameras 104 and videos (i.e., image data 130) from various malicious attacks. Moreover, in one embodiment, the image data 130 is only accessible by the camera owner (i.e. the user 176) and their authorized entities, thanks to the end-to-end encryption and user-centric key management schemes. The secure sharing of encrypted video clips and live streaming videos is also well addressed using re-encryption based on Intel SGX and key refreshing techniques.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method of authenticating a client device to access a user account stored on a remote server, the method comprising:
creating the user account based on a blockchain address of a blockchain wallet;
transmitting a login request for logging into the user account from the client device to the remote server;
transmitting a random challenge from the remote server to the client device when the remote server receives the transmitted login request, the random challenge associated with the user account and no other user account;
signing the random challenge with the client device, the signature based on a private key of the blockchain wallet;
transmitting the signed random challenge and the blockchain address to the remote server;
verifying that the signed random challenge corresponds to the transmitted random challenge with the remote server using a public key of the blockchain wallet and the random challenge;
authenticating the client device to access the user account when the verification succeeds; and
denying authentication when the verification is unsuccessful to prevent the client device from accessing the user account.

2. The method as claimed in claim 1, further comprising:
storing the private key of the blockchain wallet on a secure hardware element of the client device.

3. The method as claimed in claim 1, further comprising:
transmitting a different random challenge for each of the login requests received by the remote server.

4. The method as claimed in claim 1, further comprising:
generating the blockchain address from the public key of the blockchain wallet.

5. The method as claimed in claim 1, wherein the authenticating the user comprises:
transmitting an access token from the remote server to the client device, the access token having a limited lifespan,
wherein the authenticated client device is configured to access the user account during the lifespan of the token, and
wherein the client device is an Internet-Protocol camera.

6. The method as claimed in claim 1, wherein the creating the user account comprises:
transmitting the public key of the blockchain wallet to the remote server.

7. The method as claimed in claim 1, wherein the verifying further comprises:
identifying the random challenge with the remote server using the blockchain address.

8. The method as claimed in claim 1, further comprising:
transmitting data stored in the user account to the client device only when the client device is authenticated.

9. The method as claimed in claim 1, wherein the signing the random challenge comprises:
displaying a graphical user interface on a display of the client device; and
receiving a user input with an input device of the client device,
wherein the user input instructs the client device to sign the random challenge,
wherein the input device is a touchscreen of the client device, and
wherein the user input is a single tap on the touchscreen at a designated area of the graphical user interface.

10. A method of binding a client device to a user account stored on a remote server, the method comprising:
providing a blockchain address of the user account to the client device, the blockchain address stored on a blockchain;
transmitting the provided blockchain address of the user account and a blockchain address of the client device to the blockchain; and
executing a smart contract on the blockchain based on the transmitted blockchain address of the user account and the transmitted blockchain address of the client device, the executed smart contract configured to bind the client device to the user account.

11. The method as claimed in claim 10, wherein the binding the client device to the user account comprises:
generating a bind request when the smart contract is executed;
transmitting the bind request to the remote server, the bind request identifying the user account based on the blockchain address of the user account and identifying the client device based on the blockchain address of the client device; and
executing the transmitted bind request with the remote server by storing the blockchain address of the client device in data of the user account.

12. The method as claimed in claim 10, wherein the providing the blockchain address of the user account to the client device comprises:
displaying a visual code encoding the blockchain address of the user account on an electronic display;
reading in the displayed visual code as image data with an imaging device of the client device; and
processing the read in image data with a processor of the client device to determine the blockchain address of the user account.

13. The method as claimed in claim 12, wherein the visual code is one of a one-dimensional barcode and a two-dimensional barcode.

14. The method as claimed in claim 10, wherein:
the user account is a first user account;
a second user account has a blockchain address stored on the blockchain;
the method further comprises:
providing the blockchain address of the second user account to the client device;
transmitting the provided blockchain address of the second user account and the blockchain address of the client device to the blockchain; and
executing the smart contract based on the transmitted blockchain address of the second user account and the transmitted blockchain address of the client device, the executed smart contract configured to bind the client device to the second user account and to unbind the client device from the first user account.

15. The method as claimed in claim 14, further comprising:
transmitting data from the bound client device to the second user account;
storing the transmitted data in the second user account; and
preventing the client device bound to the second user account from accessing the first user account.

16. An Internet-connected imaging device, comprising:
an image sensor configured to generate unencrypted image data;
a memory operably connected to the image sensor; and
a secure element operably connected to the image sensor and the memory, the secure element including a private key of a blockchain wallet and a cryptographic engine,
wherein the cryptographic engine is configured (i) to derive a key encryption key based on the private key of the blockchain wallet, (ii) to store the key encryption key in the secure element, (iii) to derive a video encryption key, (iv) to encrypt the video encryption key based on the key encryption key, and (v) to store the encrypted video encryption key in the secure element, and
wherein the cryptographic engine is further configured to encrypt the unencrypted image data based on the video encryption key to generate encrypted image data.

17. The imaging device as claimed in claim 16, wherein the cryptographic engine is further configured (i) to store the encrypted image data in at least one of the memory and a remote storage, and (ii) to prevent storage of the unencrypted image data in the memory and/or the remote storage.

18. The imaging device as claimed in claim 16, wherein the cryptographic engine is configured to derive the key encryption key based on the private key and a random salt.

19. The imaging device as claimed in claim 16, further comprising:
a network device operably connected to the Internet; and
a processor operably connected to the imaging device, the memory, the secure element, and the network device,
wherein the network device is configured to receive a request to generate a new video encryption key.

20. The imaging device as claimed in claim 19, wherein:
when the request is received, the cryptographic engine is configured (i) to derive the new video encryption key, (ii) to encrypt the new video encryption key based on the key encryption key, and (iii) to store the encrypted new video encryption key in the secure element, and
the cryptographic engine is further configured to encrypt the unencrypted image data based on the new video encryption key to generate the encrypted image data.
